(19) United States
(12) Patent Application Publication
(10) Pub. No.: US 2001/0005824 A1
(43) Pub. Date: Jun. 28, 2001

(54) Sound image localization apparatus

(76) Inventors: Naoyuki Kato, Izuka (JP); Yoshinori Kumamoto, Kasuya-gun (JP)

Correspondence Address: WENDEROTH, LIND & PONACK, L.L.P., 2033 K STREET N. W., SUITE 800, WASHINGTON, DC, 20006-1021, US

(21) Appl. No.: 09/739,380

(22) Filed: Dec. 19, 2000

(30) Foreign Application Priority Data
Dec. 24, 1999 (JP) 367174/1999

(51) Int. Cl. G10L 11/04

(52) U.S. Cl. 704/206

(57) ABSTRACT

A sound image localization apparatus that can support an input signal of plurality of sampling frequencies while being small in circuitry size is provided.

A basic sound image localizer 12 processes a signal within a frequency band [0 kHz to 24 kHz] for sound image localization. A sound image localizer 13a processes a signal within a frequency band [24 kHz to 48 kHz] for sound image localization. A sound image localizer 13b processes a signal within a frequency band [48 kHz to 96 kHz] for sound image localization. An input sampling frequency detector 11 detects a sampling frequency of an input signal. A frequency band decomposing part 14 decomposes the input signal into the above frequency bands. Sound image localization is carried out on the input signal only by the basic sound image localizer 12 when the detected sampling frequency is 48 kHz; by the basic sound image localizer 12 and the sound image localizer 13a when 96 kHz; and by the basic sound image localizer 12 and the sound image localizers 13a and 13b when 192 kHz. Frequency band reconstructing parts 15a and 15b each reconstruct the signals after sound image localization.

### BACKGROUND OF THE INVENTION

1. Field of the Invention

The present invention relates to sound image localization apparatuses and, more specifically, to an apparatus for localizing sound at an arbitrary position by using two speakers, headphones, or the like.

2. Description of the Background Art

Sound image localization apparatuses localize a sound image through two speakers, headphones, or the like. In other words, those apparatuses process sound from speakers or the like as if the sound is coming from an arbitrary position. One example of conventional sound image localization apparatuses is disclosed in Japanese Patent Laid-Open Publication No. 9-233599 (1997-233599). This conventional sound image localization apparatus is now briefly described below.

FIG. 13 is a diagram in assistance of explaining the principle of a sound image localization process. In FIG. 13, sound signals outputted from two speakers 131a and 131b are denoted by XL and XR, respectively. Here, a transmission function from the speaker 131a to a left ear EL is denoted by H_{LL}, while a transmission function from the speaker 131b to a right ear ER is denoted by H_{RR}. Also, a transmission function from the speaker 131a to the right ear ER is denoted by H_{LR}, while a transmission function from the speaker 131b to the left ear EL is denoted by H_{RL}. Furthermore, transmission functions from a point O to the left ear EL and the right ear ER are denoted by T_{L} and T_{R}, respectively. Here, in fact, the two speakers 131a and 131b emit the sound signals XL and XR. However, in order to create a situation as if a sound signal u is outputted from the point O, the following equations (1) and (2) should be satisfied.

XL=F_{L}·u+F_{C1}·XR (1)

XR=F_{R}·u+F_{C2}·XL (2)

where

F_{C1}=−H_{RL}/H_{LL},

F_{C2}= −H_{LR}/H_{RR}

F_{L}=T_{L}/H_{LL},

F_{R}=T_{R}/H_{RR}

FIG. 14 shows the structure of a conventional 2-front-speaker sound image localization apparatus that satisfies the above equations (1) and (2). In FIG. 14, the conventional sound image localization apparatus includes a direction localizer 141 and a crosstalk canceller 142. The direction localizer 141 is structured by digital filters 143a and 143b structured to have transmission functions F_{L} and F_{R}, respectively. The crosstalk canceller 142 is structured by digital filters 144a and 144b structured to have transmission functions F_{C1} and F_{C2}, respectively, and adders 145a and 145b. The direction localizer 141 processes the sound signal u for direction localization to determine a location (direction) of a sound image. The crosstalk canceller 142 suppresses crosstalk components in the sound signals F_{L}·u and F_{R}·u after the direction localizing process.

The filter coefficients of the digital filters 143a, 143b, 144a, and 144b are determined by sampling frequencies to be used for the process. Moreover, to process a signal of a wide frequency band for sound image localization (that is, to increase a sampling frequency), the order of each digital frequency should be increased.

Therefore, in order to achieve a sound image localization apparatus for an input signal of a plurality of sampling frequencies, a sound image localizer (a direction localizer and a crosstalk canceller) should be provided for each sampling frequency. In this case, according to each sampling frequency of the input signal, the sound image localizers have to be switched. FIG. 15 shows an example of structure of a conventional sound image localization apparatus for an input signal of three sampling frequencies: 48 kHz, 96 KHz, and 192 kHz. In FIG. 15, sound image localizers 151a, 151b, and 151c process the input signal of the sampling frequencies f_{S} of 48 kHz, 96 KHz, and 192 kHz, respectively, for sound image localization. Therefore, the sound image localizer 151a, 151b, and 151c each process the signal of 0 to a Nyquist frequency of its sampling frequency f_{S}, that is, [0 kHz to 24 kHz], [0 kHz to 48 kHz], and [0 kHz to 96 kHz]. Here, [f1 to f2] represents a frequency band from a lower-limit frequency f1 to an upper-limit frequency f2. In this example, the lower-limit frequency f1 is 0 kHz, but may take, in actual use, 100 Hz, 200 Hz, or other values depending on filter characteristics or other factors. However, this is not the subject of the present invention, and therefore in the following description, it is assumed for convenience that the lower-limit frequency f1 always be 0 kHz no matter how it may take other values.

In general, the order of the digital filter to be required is approximately proportional to the sampling frequency f_{S}. Therefore, with reference to the order of the digital filter used in the sound image localizer 151a, the one used in the sound image localizer 151b is twice as much, and the one used in the sound image localizer 151c is fourth time as much. Also, the number of digital filter coefficients to be required is thought to be approximately proportional to the order of the digital filter. Therefore, when the number of digital filter coefficients required in the sound image localizer 151a is Nc, approximately 7Nc (=Nc+2NC+4Nc) digital filter coefficients are required in the entire sound image localization apparatus. Moreover, the operation power (the number of calculations per unit time) is thought to be proportional to the product of the order of the filter and the sampling frequency. Therefore, when the sound image localizer 151a has operation power Nm, the sound image localizer 151b has operation power 4Nm (=2×2Nm), and the sound image localizer 151c has 16Nm (=4×4Nm). Thus, the sound image localization apparatus requires the largest operation power, that is, 16Nm.

As such, in the conventional art, to achieve a sound image localization apparatus for an input signal of a plurality of sampling frequencies, a sound image localizer is required for each sampling frequency. Therefore, the number of filter coefficients and the operation power required for the apparatus are increased. That also leads to an increase in circuitry size of the apparatus.

### SUMMARY OF THE INVENTION

Therefore, an object of the present invention is to provide a sound image localization apparatus that can support an input signal of a plurality of sampling frequencies while being small in circuitry size.

The present invention has the following features to achieve the object above.

A first aspect of the present invention is directed to a sound image localization apparatus provided with a sound signal of n (n is an integer not less than 2) sampling frequencies f₁ to fₙ (each frequency satisfies fₘ₋₁<fₘ (m=2 to n) and fₘ is a multiple of f₁) for carrying out sound image localization, the apparatus comprising:

an input sampling frequency detector for detecting the sampling frequency of the sound signal;

a basic sound image localizer that operates at the sampling frequency f₁ and carries out sound image localization on a signal within a frequency band that is lower than a Nyquist frequency of the sampling frequency f₁;

a plurality of sound image localizers that operate at the sampling frequency fₘ and carry out sound image localization on a signal within a frequency band between a Nyquist frequency of the sampling frequency fₘ₋₁ and a Nyquist frequency of the sampling frequency fₘ;

a frequency band decomposing part for decomposing, based on a detection result of the input sampling frequency detector, the sound signal into signals of the frequency bands covered by the basic sound image localizer and the plurality of sound image localizers; and

a plurality of frequency band reconstructing parts for reconstructing, based on the detection result of the input sampling frequency detector, the signals outputted from the basic sound image localizer and the plurality of sound image localizers for each output channel.

Here, the plurality of sound image localizers may operate at the sampling frequency fₘ, and carry out sound image localization on a signal within a frequency band between a Nyquist frequency of the sampling frequency f₁ and a Nyquist frequency of the sampling frequency fₘ.

Furthermore, the basic sound image localizer may operate at a sampling frequency f₀ (≢f₁), which is a divisor of the sampling frequency f₁, and carry out sound image localization on a signal within a frequency band that is lower than a Nyquist frequency of the sampling frequency f₀, and

the plurality of sound image localizers may operate at the sampling frequency fₖ (k=1 to n), and carry out sound image localization on a signal within a frequency band between a Nyquist frequency of the sampling frequency f₀ and a Nyquist frequency of the sampling frequency fₖ.

As described above, according to the first aspect, when sound image localization is performed on a sound signal of a plurality of sampling frequencies, the signal is first decomposed into a predetermined plurality of frequency bands, and then subjected to sound image localization for each frequency band. Thus, sound image localization for a signal of a high sampling frequency is performed by the basic sound image localizer and one or more sound image localizers. Therefore, the circuitry of the sound image localizers can be reduced in size. Therefore, a sound image localization apparatus that is small in size, low in manufacturing cost, and low in power consumption can be achieved. Note that when the frequency f₀ is used as the sampling frequency of the basic sound image localizer, a multiple of the frequency f₀ can also be used as the sampling frequency fₘ of the plurality of sound image localizers, as well as a multiple of the frequency f₁.

A second aspect of the present invention is directed to a sound image localization apparatus provided with a plurality of sound signals of n (n is an integer not less than 2) sampling frequencies f₁ to fₙ (each frequency satisfies fₘ₋₁<fₘ (m=2 to n) and fₘ is a multiple of f₁) for carrying out sound image localization on each of the sound signals, the apparatus comprising:

an input sampling frequency detector for detecting the sampling frequency of the sound signal;

for each of the plurality of sound signals,

a basic sound image localizer that operates at the sampling frequency f₁ and carries out sound image localization on a signal within a frequency band that is lower than a Nyquist frequency of the sampling frequency f₁;

a plurality of sound image localizers that operate at the sampling frequency fₘ and carry out sound image localization on a signal within a frequency band between a Nyquist frequency of the sampling frequency fₘ₋₁ and a Nyquist frequency of the sampling frequency fₘ; and

a frequency band decomposing part for decomposing, based on a detection result of the input sampling frequency detector, the sound signal into signals of the frequency bands covered by the basic sound image localizer and the plurality of sound image localizers,

a plurality of adders for adding the signals outputted from the basic sound image localizers and the plurality of sound image localizers together for each frequency band and each output channel; and

a plurality of frequency band reconstructing parts for reconstructing, based on the detection result of the input sampling frequency detector, the signals outputted from the plurality of adders for each output channel.

As described above, according to the second aspect, the sound image localization according to the first aspect can be performed on multi-channel input signals.

Here, if each of the basic sound image localizer and the plurality of sound image localizers is separable into the structure for direction localization and the structure of crosstalk canceling,

the basic sound image localizer is replaced with a basic direction localizer that operates at the sampling frequency f₁ and carries out direction localization on a signal within a frequency band that is lower than a Nyquist frequency of the sampling frequency f₁,

the sound image localizers are replaced with a plurality of direction localizers that operate at the sampling frequency fₘ and carry out direction localization on a signal within a frequency band between a Nyquist frequency of the sampling frequency fₘ₋₁ and a Nyquist frequency of the sampling frequency fₘ,

the frequency band decomposing part decomposes, based on a detection result of the input sampling frequency detector, the sound signal into signals of the frequency bands covered by the basic direction localizer and the plurality of direction localizers,

the apparatus further includes

a plurality of adders for adding signals outputted from the basic direction localizers and the plurality of direction localizers for each frequency band and each output channel,

a basic crosstalk canceller for carrying out crosstalk cancellation on the added signals outputted from the basic direction localizers; and

a plurality of crosstalk cancellers for carrying out crosstalk cancellation on the added signals outputted from the plurality of direction localizers, and

a plurality of frequency band reconstructing parts for reconstructing, based on the detection result of the input sampling frequency detector, signals outputted from the basic crosstalk canceller and the plurality of crosstalk cancellers for each output channel.

With such structure, if each of the sound image localizer and the plurality of sound image localizers is separable into the structure for direction localization and the structure for crosstalk cancellation, the basic crosstalk canceller and the crosstalk cancellers can be shared irrespectively of the number of sound signal's channels. Thus, a sound image localization apparatus that is small in size, low in manufacturing cost, and low in power consumption can be achieved.

Note that the plurality of crosstalk cancellers may be omitted if crosstalk canceling will not become effective because as frequency becomes higher, the phase shift due to displacement from a listening position from the sound image becomes wider.

According to a third aspect of the present invention, in the first and second aspects,

the apparatus further comprises, for each of one or more sound signals,

an input format discriminator for discriminating, as to the sound signal, between a bit stream ΣΔ modulated by each bit and a multi-bit PCM bit stream,

a decimator for down-sampling the sound signal; and

a switching part for switching, for output to the frequency band decomposing part, to a signal outputted from the decimator when the input format discriminator discriminates the sound signal as the bit stream ΣΔ modulated by each bit, and to the sound signal as it is when the input format discriminator discriminates the sound signal as the multi-bit PCM bit stream.

As described above, according to the third aspect, if the sound signal is the bit stream ΣΔ modulated by each bit, the sound signal is converted into a multi-bit PCM bit stream through decimation. Thus, even if the bit stream ΣΔ modulated by each bit is provided to the apparatus, the sound image localization according to the first and second aspects can be performed.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the structure of a sound image localization apparatus according to a first embodiment of the present invention;

FIG. 2 is a diagram for assistance of explaining a frequency band to be decomposed by a frequency band decomposing part 14 of FIG. 1;

FIG. 3A is a block diagram showing one example of a two-band decomposing part circuit for decomposing a signal into two frequency bands;

FIG. 3B is a block diagram showing one example of a two-band reconstructing part circuit for reconstructing two signals of different frequency bands;

FIG. 4A is a block diagram showing one example of three-band decomposing part circuit for decomposing a signal into three frequency bands;

FIG. 4B is a block diagram showing one example of three-band reconstructing part circuit for reconstructing three signals of different frequency bands;

FIGS. 5, 6, 7 are block diagrams showing other examples of structure of the sound image localization apparatus according to the first embodiment of the present invention;

FIG. 8 is a block diagram showing the structure of a sound image localization apparatus according to a second embodiment of the present invention;

FIG. 9 is a block diagram showing other examples of structure of the sound image localization apparatus according to the second embodiment of the present invention;

FIG. 10 is a block diagram showing another structure of the sound image localization apparatus of the second embodiment adapted to an input of a five-channel digital sound signal;

FIG. 11 is a diagram showing an arrangement of speakers in a five-channel sound system;

FIG. 12 is a block diagram showing the structure of a sound image localization apparatus according to a third embodiment of the present invention;

FIG. 13 is a diagram in assistance of explaining the principle of sound localization;

FIG. 14 is a block diagram showing one example of structure of a conventional sound image localization apparatus for two speakers placed toward the front; and

FIG. 15 is a block diagram showing one example of the structure of the conventional sound image localization apparatus adapted to an input signal of a plurality of sampling frequencies.

### DESCRIPTION OF THE PREFERRED EMBODIMENTS

A sound image localization apparatus provided by the present invention can support an input signal of arbitrary number sampling frequencies that can have arbitrary values. However, in the following embodiments, it is assumed herein that the apparatus exemplarily supports one or more input signals of three sampling frequencies: 48 kHz, 96 kHz, and 192 kHz. Among the three sampling frequencies, the lowest one (48 kHz) is hereinafter referred to as a minimum input sampling frequency, while the highest one (192 kHz) as a maximum input sampling frequency.

### (First embodiment)

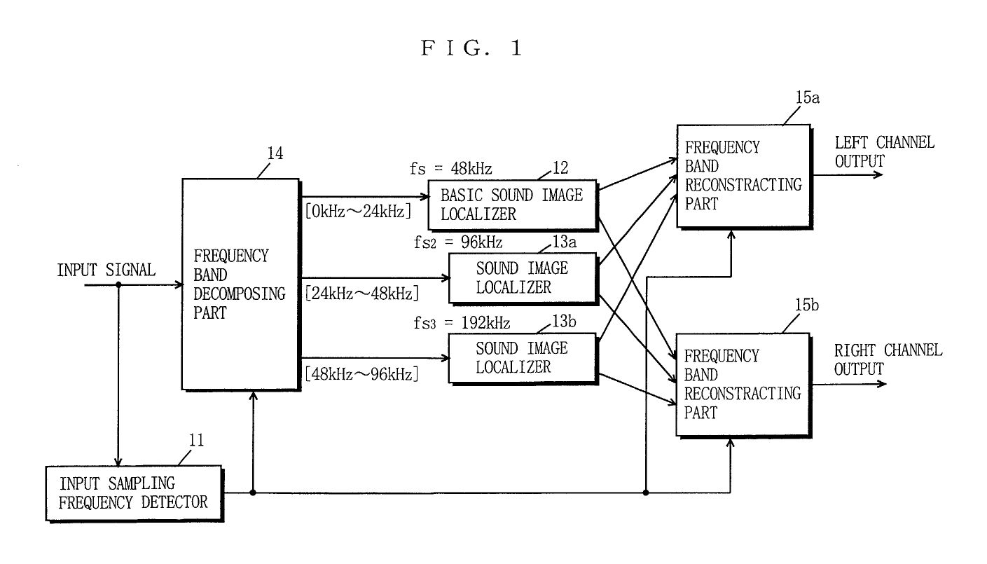

FIG. 1 is a block diagram showing the structure of a sound image localization apparatus according to a first embodiment of the present invention. In FIG. 1, the sound image localization apparatus according to the first embodiment includes an input sampling frequency detector 11, a basic sound image localizer 12, sound image localizers 13a and 13b, a frequency band decomposing part 14, and frequency band reconstructing parts 15a and 15b.

Each component of the sound image localization apparatus according to the first embodiment is now described below.

The input sampling frequency detector 11 detects a sampling frequency of an input signal, and then notifies the frequency band decomposing part 14 and the frequency band reconstructing parts 15a and 15b of the detection result. For example, when the input signal is a bit stream composed of a sound signal and sampling frequency information, the sampling frequency can be detected by extracting the sampling frequency information.

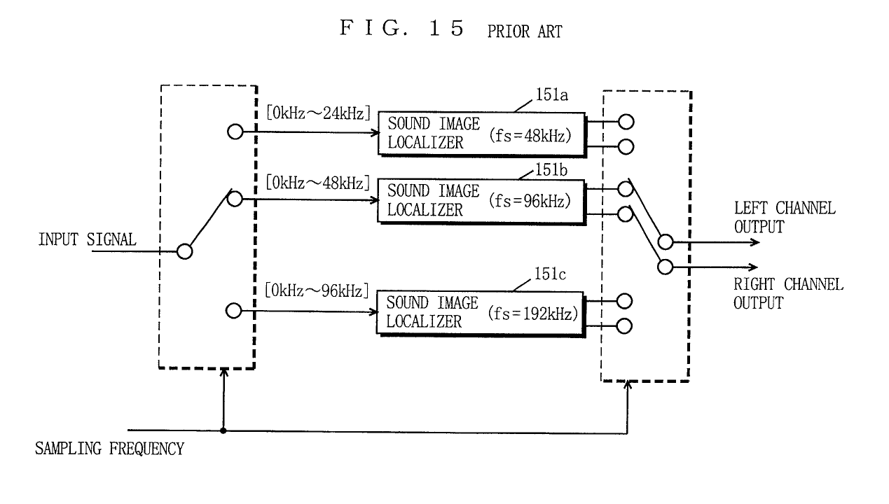

The basic sound image localizer 12 operates at a sampling frequency (hereinafter, basic frequency f_{S}) equal to the minimum input sampling frequency (48 kHz) of the input signal. The basic sound image localizer 12 processes a signal of a frequency in a range of 0 to a Nyquist frequency of the basic frequency f_{S}. The basic sound image localizer 12 is constructed in a circuit typically as shown in FIG. 14. Each filer coefficient therein is adjusted so as to be able to process a signal in a frequency band (hereinafter abbreviated as band signal) between 0 and the Nyquist frequency of the basic frequency f_{S}, that is, [0 kHz to 24 kHz], for sound image localization.

The sound image localizer 13a operates at a sampling frequency f_{S2} equal to the frequency of 96 kHz which is next larger than the basic frequency f_{S} of the input signal. The sound image localizer 13a processes a signal of a frequency in a range of a Nyquist frequency of the basic frequency f_{S} to a Nyquist frequency of the sampling frequency f_{S2}. The sound image localizer 13a is also constructed in the circuit typically as shown in FIG. 14. Each filer coefficient therein is adjusted so as to be able to process a band signal between the Nyquist frequency of the basic frequency f_{S} and that of the sampling frequency f_{S2}, that is, [24 kHz to 48 kHz], for sound image localization.

The sound image localizer 13b operates at a sampling frequency f_{S3} equal to the frequency which is next larger than the sampling frequency f_{S2}, in this case, the maximum input sampling frequency (192 kHz), of the input signal. The sound image localizer 13b processes a signal of a frequency in a range of the Nyquist frequency of the sampling frequency f_{S2} to that of the sampling frequency f_{S3}. The sound image localizer 13b is also constructed in the circuit typically as shown in FIG. 14. Each filer coefficient therein is adjusted so as to be able to process a band signal between the Nyquist frequency of the sampling frequency f_{S2} and that of the sampling frequency f_{S3}, that is, [48 kHz to 96 kHz], for sound image localization.

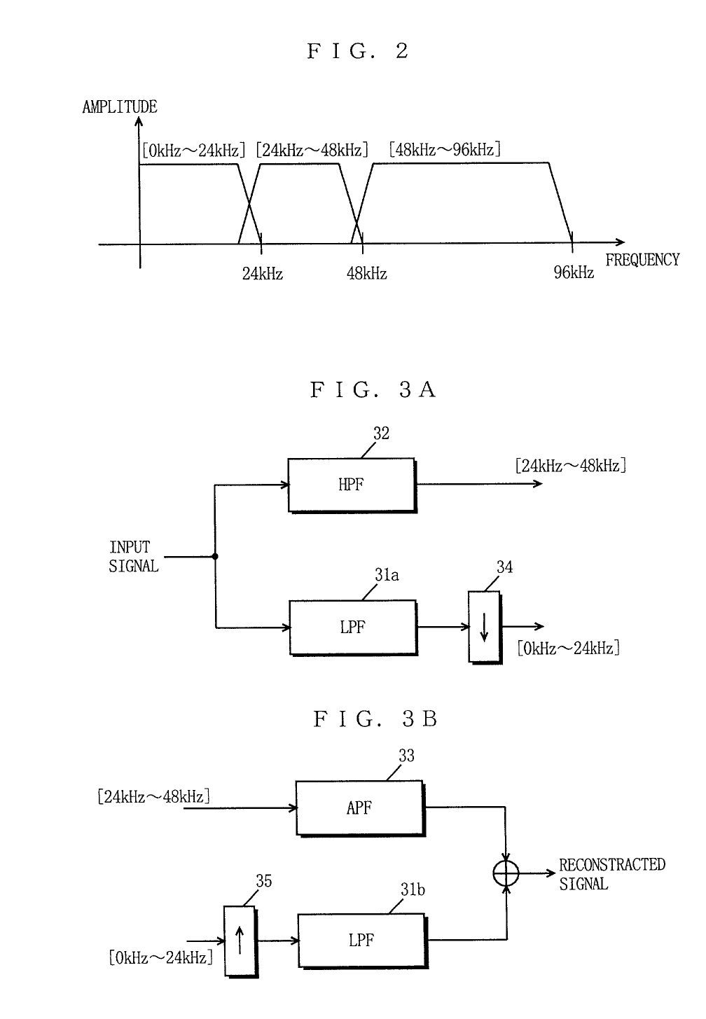

The frequency band decomposing part 14 decomposes the input signal into band signals of [0 kHz to 24 kHz], [24 kHz to 48 kHz], and [48 kHz to 96 kHz] according to the sampling frequency of the input signal detected by the input sampling frequency detector 11 and the Nyquist frequency of the sampling frequency. The sampling frequencies of these band signals are 48 kHz, 96 kHz, and 192 kHz, respectively. Note that it is substantially impossible to perform ideal band decomposing without crossover. Therefore, practically, as shown in FIG. 2, each band signal has some crossovers with its adjacent band signals.

The frequency band reconstructing part 15a reconstructs left channel signals outputted from the basic sound image localizer 12 and the sound image localizers 13a and 13b, and produces a left channel signal output at a sampling frequency equal to that of the input signal. Similarly, the frequency band reconstructing part 15b reconstructs right channel signals outputted from the basic sound image localizer 12 and the sound image localizers 13a and 13b, and produces a right channel signal output at a sampling frequency equal to that of the input signal.

The operation carried out by the sound image localization apparatus according to the first embodiment is now described in detail. The operation varies depending on the sampling frequency of the input signal, as described below.

First, the operation in a case where the sampling frequency of the input signal is 48 kHz is described. The input sampling frequency detector 11 detects the sampling frequency of the input signal as 48 kHz. Then, based on the detection result from the input sampling frequency detector 11, the frequency band decomposing part 14 outputs the input signal as it is without decomposing to the basic sound image localizer 12. This is because the input signal is, as it is, a band signal of [0 kHz to 24 kHz]. The signal outputted from the frequency band decomposing part 14 is processed in the basic sound image localizer 12 for sound image localization, provided as left and right channel signals to the frequency band reconstructing parts 15a and 15b, and outputted as they are as sound signals of the sampling frequency of 48 kHz. Note that when the sampling frequency of the input signal is 48 kHz, the sound image localizers 13a and 13b do not have to carry out the sound image localization process.

Secondly, the operation in a case where the sampling frequency of the input signal is 96 kHz is described. The input sampling frequency detector 11 detects the sampling frequency of the input signal as 96 kHz. Then, based on the detection result from the input sampling frequency detector 11, the frequency band decomposing part 14 decomposes the input signal into two band signals of [0 kHz to 24 kHz] and [24 kHz to 48 kHz]. Here, the band signal of [0 kHz to 24 kHz] is subjected to down-sampling (band-limitation and decimation by a low-pass filer), thereby down in sampling frequency to 48 kHz. This down-sampling enables the basic sound image localizer 12 to process the band signal of [0 kHz to 24 kHz] for sound image localization. The band signal of [0 kHz to 24 kHz] outputted from the frequency band decomposing part 14 is processed by the basic sound image localizer 12 for sound image localization. On the other hand, the band signal of [24 kHz to 48 kHz] outputted from the frequency band decomposing part 14 is provided as it is at the sampling frequency 96 kHz to the sound image localizer 13a for the sound image localization process. The processed band signals are provided as left and right channel signals to the frequency band reconstructing parts 15a and 15b, respectively. The band signal processed for sound image localization by the basic sound image localizer 12 is subjected to up-sampling, thereby being back to the signal of the sampling frequency of 96 kHz. Then, this band signal is reconstructed with the band signal processed by the sound image localizer 13a, and produced as a sound signal of the sampling frequency of 96 kHz. Note that when the sampling frequency of the input signal is 96 kHz, the sound image localizer 13b does not have to carry out the sound image localization process.

Circuits capable of decomposing and reconstructing the signal of two frequency bands can be realized by various circuits. One example of a 2-band decomposing circuit is shown in FIG. 3A, while one example of a 2-band reconstructing circuit is shown in FIG. 3B. In FIG. 3A, the 2-band decomposing circuit includes an LPF 31a, an HPF 32, and a down-sampler 34. In FIG. 3B, the 2-band reconstructing circuit includes an LPF 31b, an APF 33, and an up-sampler 35. The LPFs 31a and 31b, the HPF 32, and the APF 33 are digital filters. The LPFs 31a and 31b each have a predetermined low-pass characteristic. These LPFs 31a and 31b are provided to prevent occurrence of aliasing signals due to decimation. The HPF 32 has a high-pass characteristic. The APF 33 has an all-pass characteristic. The down-sampler 34 down-samples the sampling frequency to half. The up-sampler 35 up-samples the sampling frequency to be doubled.

Thirdly, the operation in a case where the sampling frequency of the input signal is 192 kHz is described. The input sampling frequency detector 11 detects the sampling frequency of the input signal as 192 kHz. Then, based on the detection result from the input sampling frequency detector 11, the frequency band decomposing part 14 decomposes the input signal into three band signals of [0 kHz to 24 kHz], [24 kHz to 48 kHz], and [48 kHz to 96 kHz]. Here, the band signals of [0 kHz to 24 kHz] and [24 kHz to 48 kHz] are subject to down-sampling, thereby down in sampling frequency to 48 kHz and 96 kHz, respectively. Then, the band signal of [0 kHz to 24 kHz] outputted from the frequency band decomposing part 14 is processed by the basic sound image localizer 12 for sound image localization. The band signal of [24 kHz to 48 kHz] outputted from the frequency band decomposing part 14 is provided to the sound image localizer 13a for the sound image localization process. On the other hand, the band signal of [48 kHz to 96 kHz] outputted from the frequency band decomposing part 14 is provided as it is at the sampling frequency 192 kHz to the sound image localizer 13b for the sound image localization process. The processed band signals are provided as left and right channel signals to the frequency band reconstructing parts 15a and 15b, respectively. The band signals processed for sound image localization by the basic sound image localizer 12 and the sound image localizer 13a are subjected to up-sampling, thereby being back to the sampling frequency 192 kHz. Then, the band signals are reconstructed with the band signal processed by the sound image localizer 13b, and produced as a sound signal of the sampling frequency of 192 kHz.

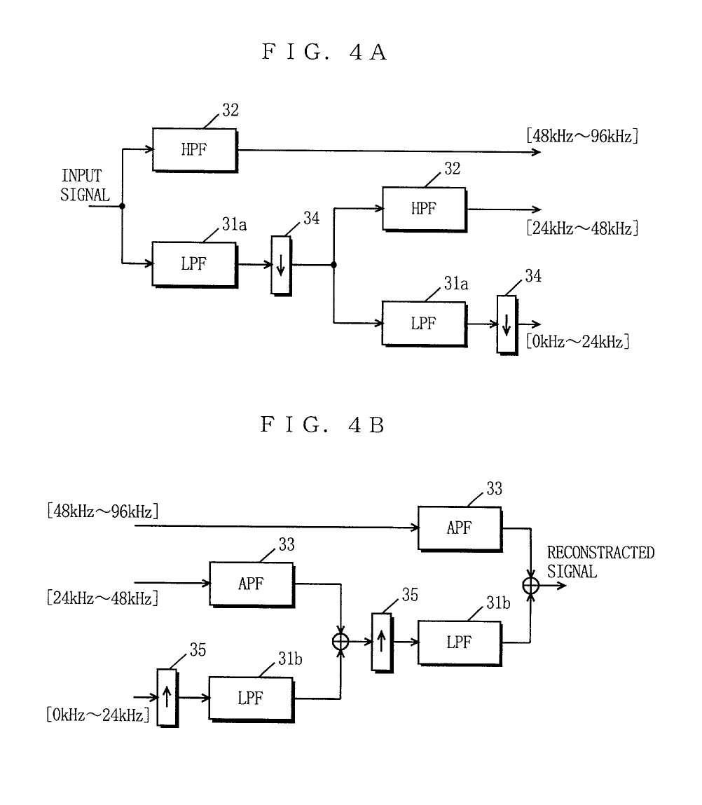

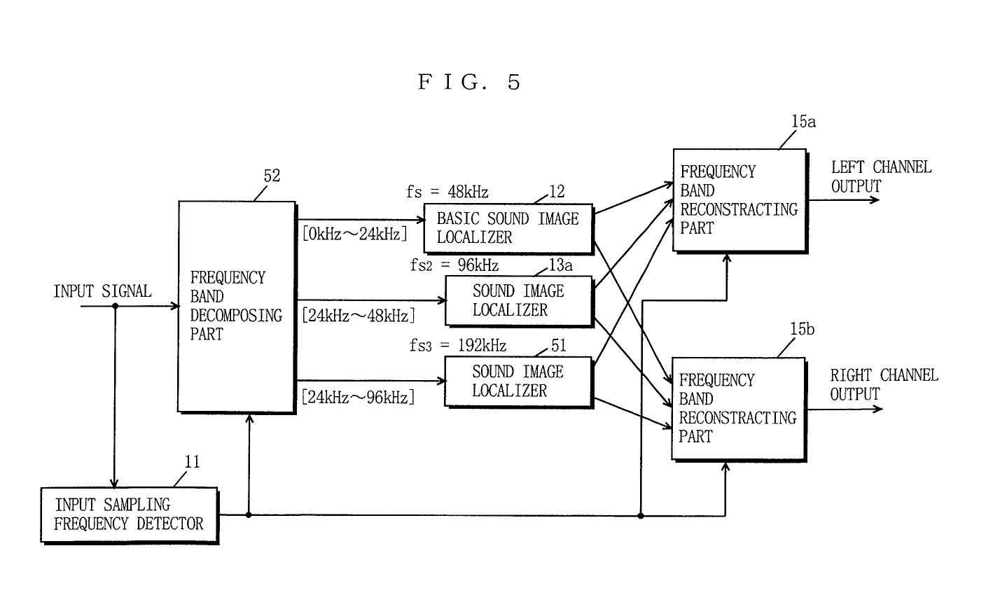

Circuits capable of decomposing and reconstructing for the signal of three frequency bands can also be realized by various circuits. For example, as shown in FIG. 4A, the structure of the 2-band decomposing circuit shown in FIG. 3A is connectively provided again subsequent to the LPF to achieve a 3-band decomposing circuit. Similarly, as shown in FIG. 4B, the structure of the 2-band reconstructing circuit shown in FIG. 3B is connectively provided again subsequent to the LPF to achieve a 3-band reconstructing circuit.

As stated above, for processing the input signal for sound image localization, decomposed band signals of [0 kHz to 24 kHz], [24 kHz to 48 kHz], [48 kHz to 96 kHz] are processed individually. Thus, the circuits for the sound image localizers 13a and 13b can be made small in structure.

Here, the effects of the present invention are considered as to the number of required filter coefficients and the operation power, compared with the method using the conventional art.

The order of filters used in the basic sound image localizer 12 is taken as reference. The sampling frequency of the sound image localizer 13a is twice as that of the basic sound image localizer 12. In the sound image localizer 13a, however, the frequency band for process is [24 kHz to 48 kHz], and therefore the bandwidth thereof is equal to that in the basic sound image localizer 12. For this reason, the order of filters in the sound localizer 13a can be thought approximately equal to that in the basic sound image localizer 12. Moreover, the sampling frequency of the sound image localizer 13b is four times as that of the basic sound image localizer 12. In the sound image localizer 13b, the frequency band for process is [48 kHz to 96 kHz], and therefore the bandwidth thereof is twice as that in the basic sound image localizer 12. For this reason, the order of filters in the sound image localizer 13b can be thought approximately twice as that in the basic sound image localizer 12. Therefore, if Nc filter coefficients are required in the basic sound image localizer 12, approximately 4Nc (=Nc+Nc+2Nc) filter coefficients are required in the entire sound image localization apparatus of the present invention. This is approximately half the number of filter coefficients required in the conventional sound image localization apparatus. Moreover, if the basic sound image localizer 12 has Nm calculation power, the sound image localizer 13a has 2Nm (=1×2Nm) calculation power, and the sound image localizer 13b has 8Nm (=2×4Nm). Accordingly, 11Nm (=Nm+2Nm+8Nm) calculation power is required in the entire sound image localization apparatus of the present invention. This is two thirds of the calculation power required in the conventional sound image localization apparatus.

Note that, the sound image localization apparatus of the present invention requires the structure of the frequency band decomposing part 14 and the frequency band reconstructing parts 15a and 15b, which is not required in the conventional apparatus, and thereby becomes large in structure. However, this structure can be implemented by a relatively small circuit, compared with the basic sound image localizer 12 and the sound image localizers 13a and 13b. Therefore, the effects of the present invention are not impaired.

Another sound image localization apparatus based on the sound image localization apparatus according to the first embodiment of the present invention is now described.

In the above embodiment, the frequency band for process by the sound image localizer 13b is between the Nyquist frequency of the sampling frequency f_{S2} and that of the sampling frequency f_{S3}, that is, [48 kHz to 96 kHz]. This frequency band can be set between the Nyquist frequency of the basic frequency f_{S} and that of the sampling frequency f_{S3}, that is, [24 kHz to 96 kHz]. In this case, the structure of the sound image localization apparatus becomes as shown in FIG. 5. In FIG. 5, the frequency band for process by the basic sound image localizer 12 is set to [0 kHz to 24 kHz], and that by sound image localizers 13a and 51 are [24 kHz to 48 kHz] and [24 kHz to 96 kHz], respectively. Thus, when the sampling frequency of the input signal is 48 kHz, only the basic sound image localizer 12 is required for sound image localization. When 96 kHz, the basic sound image localizer 12 and the sound image localizer 13a will do. When 192 kHz, the basic sound image localizer 12 and the sound image localizer 51 will do. A frequency band decomposing part 52 decomposes the input signal into band signals of [0 kHz to 24 kHz], [24 kHz to 48 kHz], and [24 kHz to 96 kHz], based on the sampling frequency detected by the input sampling frequency detector 11. The frequency band reconstructing parts 15a and 15b each reconstruct the processed band signals, and produce a signal at a sampling frequency equal to that of the input signal. With this process band setting, only the basic sound image localizer 12 and any one of the sound image localizers will do for sound image localization.

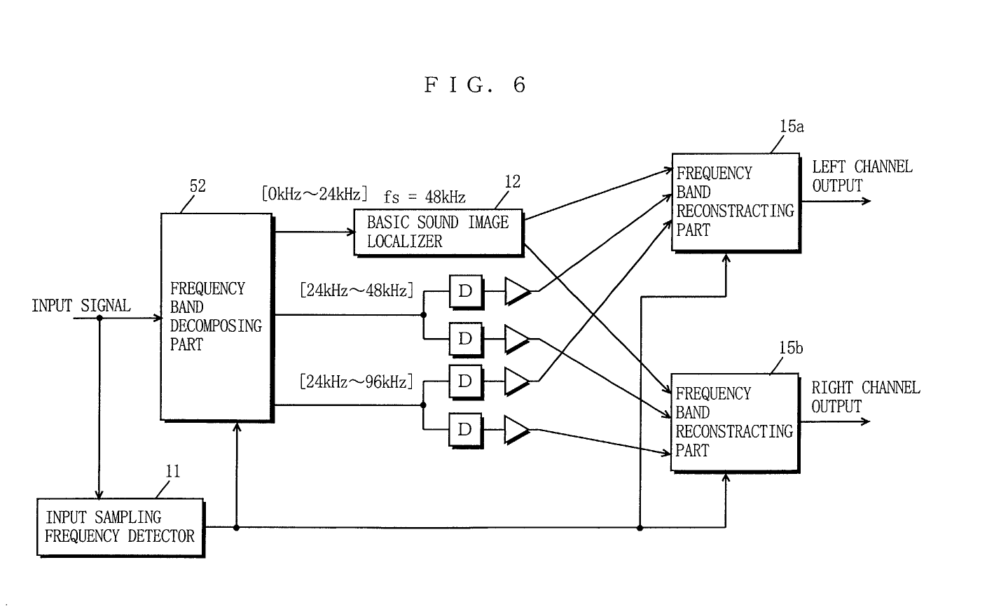

The sound image localization apparatus can be more simplified in structure by the sound image localizers 13a and 13b carrying out only simple filtering (small in order) or carrying out delay processing and sound volume adjusting as shown in FIG. 6. The reasons are as follows: The resolution of human hearing is logarithmically decreased as the frequency becomes higher. High-frequency signals (more than 10 kHz, for example) are less involved in sound image localization, and sounds of frequencies over 20 kHz are generally not audible. In addition, as the frequency becomes higher, the wavelength becomes shorter, and therefore, even a small difference between hearing positions may make it difficult to carry out sound image localization at higher frequency.

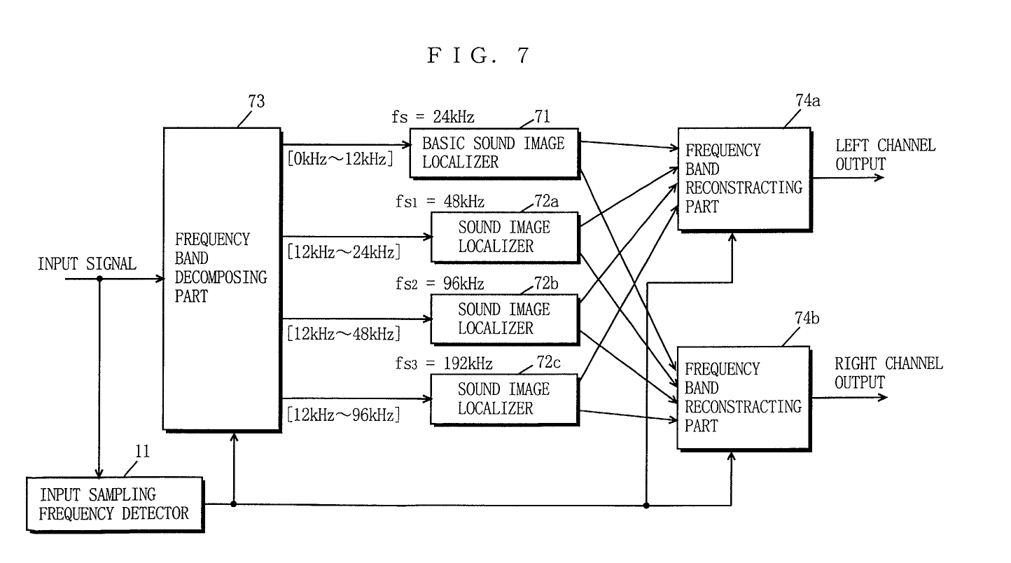

In the above embodiment, the basic frequency f_{S} is equal to the minimum input sampling frequency. Alternatively, a divisor of the minimum input sampling frequency may be used for the basic frequency f_{S} for sound image localization. For example, if the minimum input sampling frequency is 48 kHz, its divisor such as 24 kHz or 12 kHz can be used. With reference to FIG. 7, a case where the basic frequency f_{S} is 24 kHz is now described below.

In this case, the basic frequency f_{S} is 24 kHz, which is half the minimum input sampling frequency 48 kHz. Therefore, a basic sound image localizer 71 covers [0 kHz to 12 kHz]. Sound image localizers 72a, 72b, and 72c cover [12 kHz to 24 kHz], [12 kHz to 48 kHz], and [12 kHz to 96 kHz], respectively. Thus, the basic sound image localizer 71 and the sound image localizer 72a process the input signal for sound image localization when the sampling frequency is 48 kHz; the basic sound image localizer 71 and the sound image localizer 72b do when 96 kHz; and the basic sound image localizer 71 and the sound image localizer 72c do when 192 kHz. A frequency band decomposing part 73 decomposes the input signal into band signals of [0 kHz to 12 kHz], [12 kHz to 24 kHz], [12 kHz to 48 kHz], and [12 kHz to 96 kHz], according to the sampling frequency detected by the input sampling frequency detector 11. Frequency band reconstructing parts 74a and 74b each reconstruct the band signals after sound image localization, and then produce a signal at a sampling signal equal to that of the input signal.

Other various band decomposing methods can be thought. Also in such cases, each band for process and the number of sound image localizers are appropriately determined so as to enable sound image localization for each sampling frequency.

In the above embodiment, the case where the sampling frequency of the input signal can take values of 48 kHz, 96 kHz, and 192 kHz has been described. Also in a case where the sampling frequency can take other frequency values (for example, 44.1 kHz, 88.2 kHz, and 176.4 kHz), sound image localization can be similarly achieved by a structure using basic sound image localizer and one or more sound image localizers for each sampling frequency.

Furthermore, in general, the circuits of the basic sound image localizer and sound image localizers may vary in structure depending on whether 2-front-speakers or headphones. If the present invention is applied to headphones, headphone-dedicated sound image localization circuits have to be used. One example of such headphone-dedicated sound image localization circuit is disclosed in Japanese Patent Laid-Open Publication No. 8-182100 (1996-182100).

### (Second Embodiment)

In the first embodiment, the sound image localization apparatus for carrying out sound image localization process on a 1-channel input signal is described. Here, a sound image localization apparatus for carrying out the process on multi-channel input signals is described. Hereinafter, a sound image localization apparatus for carrying out the process on 2-channel input signals is exemplarily described.

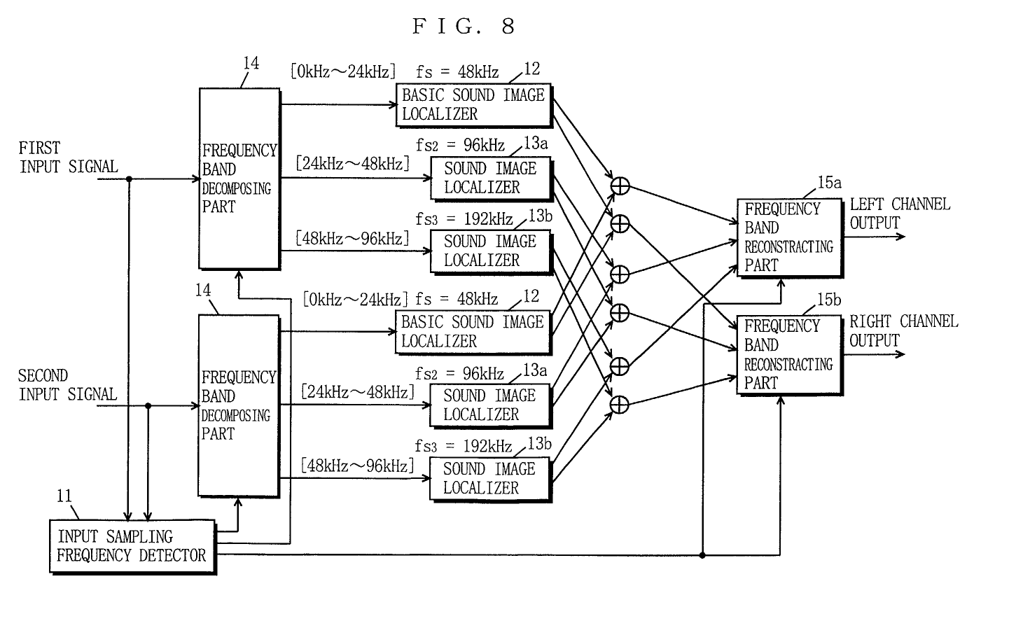

FIG. 8 is a block diagram showing the structure of the sound image localization apparatus according to a second embodiment of the present invention. In FIG. 8, the sound image localization apparatus according to the second embodiment includes the input sampling frequency detector 11, two basic sound image localizers 12, two sound image localizers 13a and 13b, two frequency band decomposing parts 14, and six adders 16a to 16f, and the frequency band reconstructing parts 15a and 15b.

As shown in FIG. 8, the sound image localization apparatus according to the second embodiment are provided with two sets of the frequency band decomposing part 14, the basic sound image localizer 12, and the sound image localizers 13a and 13b. In the sound image localization apparatus according to the second embodiment, the sound image localization process described in the first embodiment is performed on each of first and second input signals. The resultant signals are added up for each frequency band by the adders 16a to 16f, and then provided to the frequency band reconstructing parts 15a and 15b. Then, the frequency band reconstructing parts 15a and 15b each produce a sound signal at a sampling frequency equal to that of the input signal.

As such, in sound image localization for multi-channel input signals, the frequency band reconstructing parts 15a and 15b can be shared irrespectively of the number of channels. Therefore, the circuits can be reduced in size. Note that, in sound image localization for input signals of three or more channels, the set of the basic sound image localizer 12 and the sound image localizers 13a and 13b are provided as many as the number of channels.

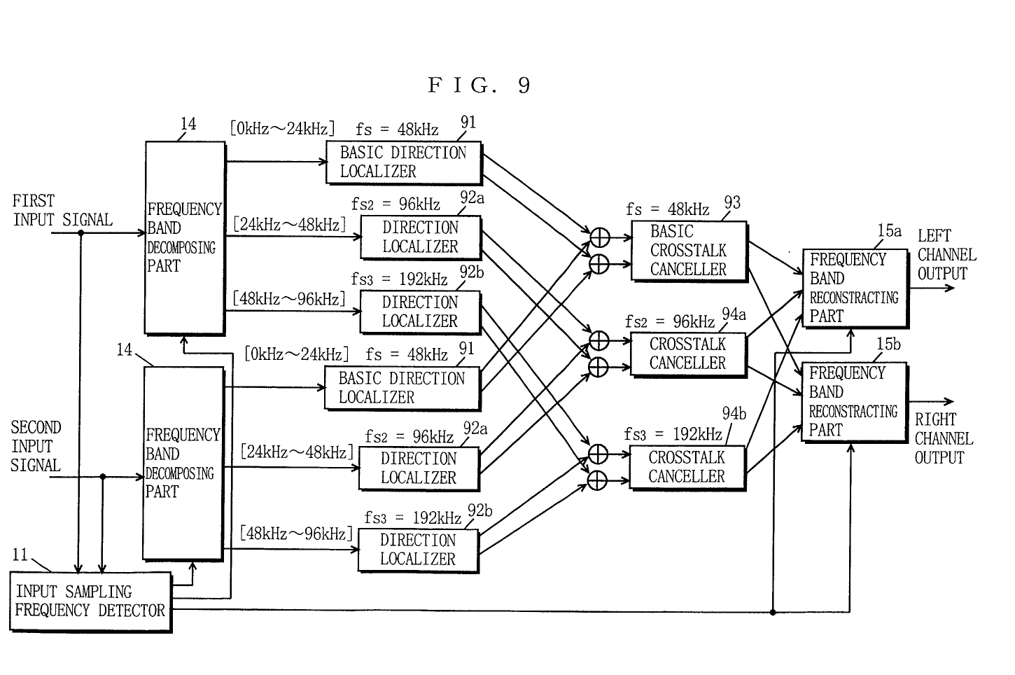

Here, in the sound image localization apparatus shown in FIG. 8, consider a case where, as to the basic sound image localizer 12 and the sound image localizers 13a and 13b, the direction localizer 141 and the crosstalk canceller 142 of each localizer are separately structured shown in FIG. 14. In such structure, the crosstalk canceller 142 can be shared, as shown in FIG. 9. A sound image localization apparatus shown in FIG. 9 has a structure in which a basic direction localizer 91 and a basic crosstalk canceller 93 replace the basic sound image localizer 12; a direction localizer 92a and a crosstalk canceller 94a replace the sound image localizer 13a; and a direction localizer 92b and a crosstalk canceller 94b replace the sound image localizer 13b. As such, output signals from the basic direction localizer 91 and the direction localizers 92a and 92b are added up for each frequency band by the adders 16a to 16f, and then subjected to crosstalk canceling. Therefore, in the sound image localization apparatus, the basic crosstalk canceller 93 and the crosstalk cancellers 94a and 94b can be shared for each frequency band. Also, the circuits can be further reduced in size.

In some cases, crosstalk canceling will not go well because as the frequency becomes higher, the phase shift due to displacement of a listening position from the sound image becomes wider. In such cases, the crosstalk cancellers 94a and 94b may be omitted. At this time, only the channel signals in a direction of a localized sound image may be outputted from the direction localizers 92a and 92b.

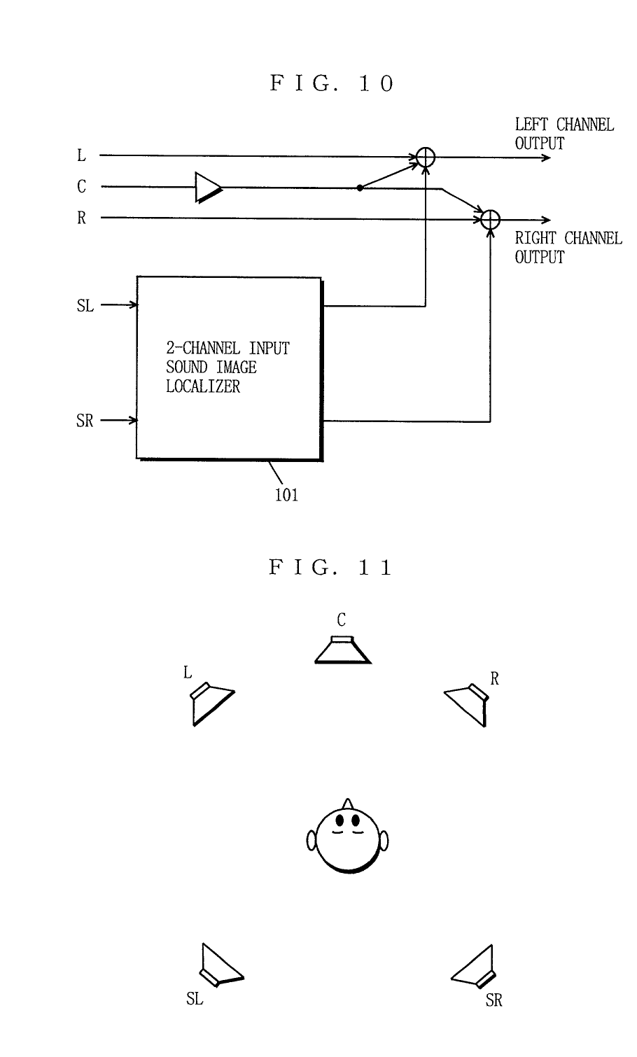

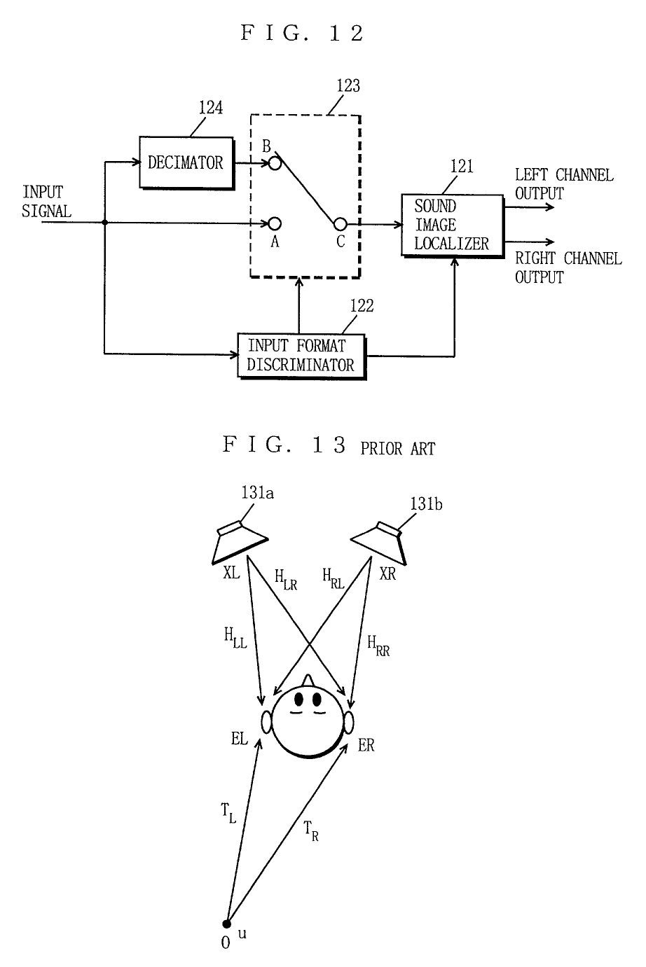

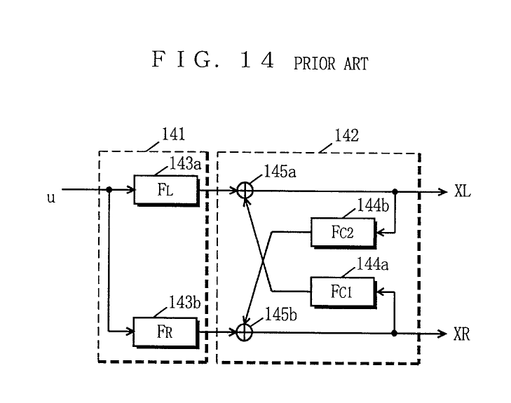

A circuit in a case where the present invention is applied to 5-channel digital sound signals used for DVD-Video, DVD-Audio, and others is shown in FIG. 10. Five channels correspond to, as shown in FIG. 11, front-left L, front-right R, center-front C, rear-left SL, and rear-right SR. Normally, five speakers are placed corresponding to the five channels for sound image localization. In a sound image localization apparatus shown in FIG. 10, however, two speakers arranged at L and R channel positions are used for sound image localization for five channels.

In FIG. 10, for the L and R channels, sound image localization is not required because their actual speaker positions are equal to their sound source positions. For C channel, phantom processing is performed, wherein the signal is multiplied by an appropriate coefficient, and then decomposed into right and left-channel signals. For SL and SR channels, a 2-channel input sound image localizer 101 (FIG. 8 or 9) that can process 2-channel input signals as described above is used for sound image localization. Alternatively, for the L, C, and R channels, a delay circuit may be provided before the signals are added in order to delay inputs for a time delayed in the 2-channel input sound image localizer 101, thereby reducing output time differences among all channels.

### (Third Embodiment)

In the above first and second embodiments, described are the sound image localization apparatuses for localizing a sound image when the input signal is a general sound signal (for example, multi-bit PCM bit stream). Described in a third embodiment is a sound image localization apparatus that can support not only a multi-bit PCM bit stream but also a bit stream obtained by ΣΔ modulating a sound signal by each bit (hereinafter, ΣΔ modulated bit stream) used in a super audio CD (described in Super Audio CD System Description).

FIG. 12 is a block diagram showing the structure of the sound image localization apparatus according to the third embodiment of the present invention. In FIG. 12, the sound image localization apparatus according to the third embodiment includes an input format discriminator 122, a switch 123, a decimator 124, and a sound image localizer 121. The input format discriminator 122 discriminates, as to the input signal, between a ΣΔ modulated bit stream or a multi-bit PCM bit stream. The decimator 124 down-samples the input signal to a sampling frequency supported by the sound image localizer 121. The switch 123 selectively switches between the input signal as it is or down-sampled input signal based on the discrimination result by the input format discriminator 122. Then, the switch 123 outputs the selected signal to the sound image localizer 121. The sound image localizer 121 is equivalent to the sound image localization apparatus according to the first embodiment. Based on the discrimination result by the input format discriminator 122, the sound image localizer 121 subjects the signal outputted from the switch 123 to the sound image localization process. Here, the sampling frequency of the ΣΔ modulated bit stream is 2822.4 kHz (=44.1 kHz×64). Therefore, the sound image localizer 121 is implemented by the sound image localization apparatus according to the first embodiment capable of process an input signal of 44.1 kHz, 88.2 kHz, and 176.4 kHz for sound image localization.

The operation of the sound image localization apparatus according to the third embodiment is now described. First, the input format discriminator 122 discriminates, as to the input signal, between a ΣΔ modulated bit stream or a multi-bit PCM bit stream. The discrimination result is given to the switch 123 and the sound image localizer 121. The operation thereafter varies based on the discrimination result.

Described first is a case where the input signal is a multi-bit PCM bit stream. In this case, the switch 123 connects a terminal A and a terminal C together, outputting the input signal as it is to the sound image localizer 121. The sound image localizer 121 subjects the received input signal to the sound image localization process similar to that in the first embodiment. In this case, the decimator 124 does not have to operate.

Described next is a case where the input signal is a ΣΔ A modulated bit stream. In this case, the decimator 124 eliminates an aliasing signal (unnecessary component) from the input signal. Then, the decimator 124 down-samples the resultant signal to a multi-bit PCM bit stream at a sampling frequency of 176.4 kHz that can be processed by the sound image localizer 121. The switch 123 connects a terminal B and the terminal C together, outputting the down-sampled input signal to the sound image localizer 121. The sound image localizer 121 subjects the received signal to sound image localization process similar to that of the first embodiment. At this time, the input sampling frequency detector 11 of the sound image localizer 121 is given information from the input format discriminator 122 that the sampling frequency of the input signal is 176.4 kHz. Therefore, the sound image localizer 121 outputs a sound signal at a sampling frequency 176.4 kHz.

Thus, sound image localization can be performed also on the ΣΔ modulated bit stream. In the present embodiment, considered is a case where the input signal is a 1-channel signal. Alternatively, by using a sound image localization apparatus supporting multi-channel input signals as shown in the second embodiment and providing a plurality of decimators 124 and switches 123, multi-channel input signals can also be processed.

While the invention has been described in detail, the foregoing description is in all aspects illustrative and not restrictive. It is understood that numerous other modifications and variations can be devised without departing from the scope of the invention.

What is claimed is:

1. A sound image localization apparatus provided with a sound signal of n (n is an integer not less than 2) sampling frequencies f₁ to fₙ (each frequency satisfies fₘ₋₁<fₘ (m=2 to n) and fₘ is a multiple of f₁) for carrying out sound image localization, said apparatus comprising:
an input sampling frequency detector for detecting the sampling frequency of said sound signal;
a basic sound image localizer that operates at said sampling frequency f₁ and carries out sound image localization on a signal within a frequency band that is lower than a Nyquist frequency of the sampling frequency f₁;
a plurality of sound image localizers that operate at said sampling frequency fₘ and carry out sound image localization on a signal within a frequency band between a Nyquist frequency of said sampling frequency fₘ₋₁ and a Nyquist frequency of the sampling frequency fₘ;
a frequency band decomposing part for decomposing, based on a detection result of said input sampling frequency detector, said sound signal into signals of the frequency bands covered by said basic sound image localizer and said plurality of sound image localizers; and
a plurality of frequency band reconstructing parts for reconstructing, based on the detection result of said input sampling frequency detector, the signals outputted from said basic sound image localizer and said plurality of sound image localizers for each output channel.

2. A sound image localization apparatus provided with a sound signal of n (n is an integer not less than 2) sampling frequencies f₁ to fₙ (each frequency satisfies fₘ₋₁<fₘ (m=2 to n) and fₘ is a multiple of f₁) for carrying out sound image localization, said apparatus comprising:
an input sampling frequency detector for detecting the sampling frequency of said sound signal;
a basic sound image localizer that operates at said sampling frequency f₁ and carries out sound image localization on a signal within a frequency band that is lower than a Nyquist frequency of the sampling frequency f₁;
a plurality of sound image localizers that operate at said sampling frequency fₘ and carry out sound image localization on a signal within a frequency band between a Nyquist frequency of said sampling frequency f₁ and a Nyquist frequency of the sampling frequency fₘ;
a frequency band decomposing part for decomposing, based on a detection result of said input sampling frequency detector, said sound signal into signals of the frequency bands covered by said basic sound image localizer and said plurality of sound image localizers; and
a plurality of frequency band reconstructing parts for reconstructing, based on the detection result of said input sampling frequency detector, the signals outputted from said basic sound image localizer and said plurality of sound image localizers for each output channel.

3. A sound image localization apparatus provided with a sound signal of n (n is an integer not less than 2) sampling frequencies f₁ to fₙ (each frequency satisfies fₖ₋₁<fₖ (k=1 to n)) for carrying out sound image localization, said apparatus comprising:
an input sampling frequency detector for detecting the sampling frequency of said sound signal;
a basic sound image localizer that operates at a sampling frequency f₀, which is a divisor of said sampling frequency f₁, and carries out sound image localization on a signal within a frequency band that is lower than a Nyquist frequency of the sampling frequency f₀;
a plurality of sound image localizers that operate at said sampling frequency fₖ and carry out sound image localization on a signal within a frequency band between a Nyquist frequency of said sampling frequency f₀ and a Nyquist frequency of the sampling frequency fₖ;
a frequency band decomposing part for decomposing, based on a detection result of said input sampling frequency detector, said sound signal into signals of the frequency bands covered by said basic sound image localizer and said plurality of sound image localizers; and
a plurality of frequency band reconstructing parts for reconstructing, based on the detection result of said input sampling frequency detector, the signals outputted from said basic sound image localizer and said plurality of sound image localizers for each output channel.

4. A sound image localization apparatus provided with a plurality of sound signals of n (n is an integer not less than 2) sampling frequencies f₁ to fₙ (each frequency satisfies fₘ₋₁<fₘ (m=2 to n) and fₘ is a multiple of f₁) for carrying out sound image localization on each of said sound signals, said apparatus comprising:
an input sampling frequency detector for detecting the sampling frequency of said sound signal;
for each of said plurality of sound signals,
a basic sound image localizer that operates at said sampling frequency f₁ and carries out sound image localization on a signal within a frequency band that is lower than a Nyquist frequency of the sampling frequency f₁;
a plurality of sound image localizers that operate at said sampling frequency fₘ and carry out sound image localization on a signal within a frequency band between a Nyquist frequency of said sampling frequency fₘ₋₁ and a Nyquist frequency of the sampling frequency fₘ; and
a frequency band decomposing part for decomposing, based on a detection result of said input sampling frequency detector, said sound signal into signals of the frequency bands covered by said basic sound image localizer and said plurality of sound image localizers,
a plurality of adders for adding signals outputted from said basic sound image localizers and said plurality of sound image localizers together for each frequency band and each output channel; and
a plurality of frequency band reconstructing parts for reconstructing, based on the detection result of said input sampling frequency detector, signals outputted from said plurality of adders for each output channel.

5. A sound image localization apparatus provided with a plurality of sound signals of n (n is an integer not less than 2) sampling frequencies f₁ to fₙ (each frequency satisfies fₘ₋₁<fₘ (m=2 to n) and fₘ is a multiple of f₁) for carrying out sound image localization on each of said sound signals, said apparatus comprising:
an input sampling frequency detector for detecting the sampling frequency of said sound signal;
for each of said plurality of sound signals,
a basic direction localizer that operates at said sampling frequency f₁ and carries out direction localization on a signal within a frequency band that is lower than a Nyquist frequency of the sampling frequency f₁;
a plurality of direction localizers that operate at said sampling frequency fₘ and carry out direction localization on a signal within a frequency band between a Nyquist frequency of said sampling frequency fₘ₋₁ and a Nyquist frequency of the sampling frequency fₘ; and
a frequency band decomposing part for decomposing, based on a detection result of said input sampling frequency detector, said sound signal into signals of the frequency bands covered by said basic direction localizer and said plurality of direction localizers,
a plurality of adders for adding signals outputted from said basic direction localizers and said plurality of direction localizers for each frequency band and each output channel,
a basic crosstalk canceller for carrying out crosstalk cancellation on the added signals outputted from said basic direction localizers; and
a plurality of frequency band reconstructing parts for reconstructing, based on the detection result of said input sampling frequency detector, signals outputted from any of said plurality of adders that are dedicated to said plurality of direction localizers and the signal outputted from said basic crosstalk canceller for each output channel.

6. A sound image localization apparatus provided with a plurality of sound signals of n (n is an integer not less than 2) sampling frequencies f₁ to fₙ (each frequency satisfies fₘ₋₁<fₘ (m=2 to n) and fₘ is a multiple of f₁) for carrying out sound image localization on each of said sound signals, said apparatus comprising:
an input sampling frequency detector for detecting the sampling frequency of said sound signal;
for each of said plurality of sound signals,
a basic direction localizer that operates at said sampling frequency f₁ and carries out direction localization on a signal within a frequency band that is lower than a Nyquist frequency of the sampling frequency f₁;
a plurality of direction localizers that operate at said sampling frequency fₘ and carry out direction localization on a signal within a frequency band between a Nyquist frequency of said sampling frequency fₘ₋₁ and a Nyquist frequency of the sampling frequency fₘ; and
a frequency band decomposing part for decomposing, based on a detection result of said input sampling frequency detector, said sound signal into signals of the frequency bands covered by said basic direction localizer and said plurality of direction localizers,
a plurality of adders adding signals outputted from said basic direction localizers and said plurality of direction localizers for each frequency band and each output channel,
a basic crosstalk canceller for carrying out crosstalk cancellation on the added signals outputted from said basic direction localizers;
a plurality of crosstalk cancellers for carrying out crosstalk cancellation on the added signals outputted from said plurality of direction localizers; and
a plurality of frequency band reconstructing parts for reconstructing, based on the detection result of said input sampling frequency detector, signals outputted from said basic crosstalk canceller and said plurality of crosstalk cancellers for each output channel.

7. The sound image localization apparatus according to claim 1, further comprising:
an input format discriminator for discriminating, as to said sound signal, between a bit stream ΣΔ modulated by each bit and a multi-bit PCM bit stream,
a decimator for down-sampling said sound signal; and
a switching part for switching, for output to said frequency band decomposing part, to a signal outputted from said decimator when said input format discriminator discriminates said sound signal as the bit stream ΣΔ modulated by each bit, and to said sound signal as it is when said input format discriminator discriminates said sound signal as the multi-bit PCM bit stream.

8. The sound image localization apparatus according to claim 2, further comprising:
an input format discriminator for discriminating, as to said sound signal, between a bit stream ΣΔ modulated by each bit and a multi-bit PCM bit stream,
a decimator for down-sampling said sound signal; and
a switching part for switching, for output to said frequency band decomposing part, to a signal outputted from said decimator when said input format discriminator discriminates said sound signal as the bit stream ΣΔ modulated by each bit, and to said sound signal as it is when said input format discriminator discriminates said sound signal as the multi-bit PCM bit stream.

9. The sound image localization apparatus according to claim 3, further comprising:
an input format discriminator for discriminating, as to said sound signal, between a bit stream ΣΔ modulated by each bit and a multi-bit PCM bit stream,
a decimator for down-sampling said sound signal; and
a switching part for switching, for output to said frequency band decomposing part, to a signal outputted from said decimator when said input format discriminator discriminates said sound signal as the bit stream ΣΔ modulated by each bit, and to said sound signal as it is when said input format discriminator discriminates said sound signal as the multi-bit PCM bit stream.

10. The sound image localization apparatus according to claim 4, further comprising:
for each of said sound signals,
an input format discriminator for discriminating, as to said sound signal, between a bit stream ΣΔ modulated by each bit and a multi-bit PCM bit stream,
a decimator for down-sampling said sound signal; and
a switching part for switching, for output to said frequency band decomposing part, to a signal outputted from said decimator when said input format discriminator discriminates said sound signal as the bit stream ΣΔ modulated by each bit, and to said sound signal as it is when said input format discriminator discriminates said sound signal as the multi-bit PCM bit stream.

11. The sound image localization apparatus according to claim 5, further comprising:
for each of said sound signals,
an input format discriminator for discriminating, as to said sound signal, between a bit stream ΣΔ modulated by each bit and a multi-bit PCM bit stream,
a decimator for down-sampling said sound signal; and
a switching part for switching, for output to said frequency band decomposing part, to a signal outputted from said decimator when said input format discriminator discriminates said sound signal as the bit stream ΣΔ modulated by each bit, and to said sound signal as it is when said input format discriminator discriminates said sound signal as the multi-bit PCM bit stream.

12. The sound image localization apparatus according to claim 6, further comprising:
for each of said sound signals,
an input format discriminator for discriminating, as to said sound signal, between a bit stream ΣΔ modulated by each bit and a multi-bit PCM bit stream,
a decimator for down-sampling said sound signal; and
a switching part for switching, for output to said frequency band decomposing part, to a signal outputted from said decimator when said input format discriminator discriminates said sound signal as the bit stream ΣΔ modulated by each bit, and to said sound signal as it is when said input format discriminator discriminates said sound signal as the multi-bit PCM bit stream.
